(19) United States
(12) Patent Application Publication
(10) Pub. No.: US 2012/0303635 A1
(43) Pub. Date: Nov. 29, 2012

(54) System and Method for Computing and Displaying a Score with an Associated Visual Quality Indicator

(76) Inventor: Adam Summers, Glen Burnie, MD (US)

(21) Appl. No.: 13/207,804

(22) Filed: Aug. 11, 2011

Related U.S. Application Data
(63) Continuation-in-part of application No. 12/228,876, filed on Aug. 15, 2008, now abandoned.

(51) Int. Cl. G06F 17/30

(52) U.S. Cl. 707/748; 707/E17.044

(57) ABSTRACT

A system and method for computing and transforming (1) a rating and (2) an indicator of the quality of the rating into (3) a new visual indicator which may be stored or output. A rating, also known as a score, can be the result of a survey or come from any other source. An indicator representing the quality of a rating can include a series of different colors, individual icons, a series of multiple icons, or written text. A new visual indicator is created from the combination of the rating and quality indicator. The system can analyze available data or accept human input and create an indicator of the quality of each rating or adjusted rating. The invention can create a new visual indicator by combining supplied or computed ratings and their computed quality indicators. The visual indicator may be stored as data elements or output on any capable device.

This is a continuation-in-part of co-pending application Ser. No. 12/228,876 filed Aug. 15, 2008. Application Ser. No. 12/228,876 is hereby incorporated by reference.

### BACKGROUND

1. Field of the Invention

The present invention relates generally to the field of computing and generating output in the form of a display or printed material and more particularly to a system and method of transforming a multitude of data into a visual indicator for output.

2. Description of the Prior Art

A variety of grading or scoring systems are commonly used throughout numerous industries to describe the quality of a particular person, place, product, service or event. Also, there are numerous scales and ways to grade. For example, one survey might result in an overall rating of 8 on a scale of 1-10 for some product. A different survey might result in an overall rating or score of “B+” on a scale of “F” to “A+”. In order to determine a rating or score, raters typically sample the product and then answer survey questions concerning multiple criteria. An overall score could be calculated based on the average of the individual responses.

For example, a survey evaluating a hand cream might require a numerical answer to a group of questions where there is a scale: 1=strongly disagree, . . . 5=agree, . . . 10=strongly agree. The questions might then be a series of statements:
1. The cream absorbs well.
2. The cream smells good.
3. The bottle is easy to use.
4. The presentation of the bottle and label are overall very attractive.
5. The directions are clear on how to use the cream.
6. The price is favorable.
7 . . . .
   A particular rater might answer: 1=10, 2-5, 3-2, 4-7, 5-1, 6-7,

In order to get an overall score for this particular rater, an average might be used. In this case, the average is (10+5+2+7+1+7)/6=5⅓. There are numerous other ways to generate overall ratings. In some cases, particular questions might be weighted more than others. When scores are tallied, the manufacturer can decide if the product has enough market appeal, and potential users can make a decision as to whether the product is something they would be interested in using or purchasing.

Unfortunately, there are a number of issues surrounding the reporting of these scores or ratings that reduces their reliability including rater biases and rater sample sizes.

First, a skew in the characteristics of the raters can seriously affect the ratings. In the example of the hand cream, women raters might care much more how the product smells than men. People with a particular type of skin or complexion might care more about how the cream is absorbed than others. In these examples, the experience and/or demographics of a rater will influence their individual rating. Other consumers contemplating a product purchase may be more interested in the ratings from raters with demographics and/or experiences similar to the consumer, Some systems attempt to communicate the demographics of their participating raters using graphs and tables, but this does not enable the consumer to quickly make a decision regarding the quality of the ratings or easily compare multiple ratings of multiple products.

Second, another serious danger in any rating system is when the sample size is too small. For example, if 10 raters give a product an “A” in a first survey, and 1000 raters give the product an “A” in second survey, the “A” grade from the second survey means more than that from the first survey simply because the probability of a large sample group all voting the same way randomly is very small, and thus a large positive vote is a good indication for the product. As an example of this, if there are 2 choices, the probability of a rater choosing one of them randomly is 0.5. The probability of 10 raters choosing the same number randomly is (0.5)¹⁰=0.000976, while the probability of 1000 raters choosing the same number randomly is (0.5)¹⁰⁰⁰=(a very, very, very small number). Thus, it is widely held that the larger the sample size, the more reliable the results are. Recognizing this, some rating and review systems now report the sample size next to the average rating displayed for a product or service, the implication being consumers can rely on their reviews because the sample size reported is large.

Third, ratings reported as averages (“mean scores”) along with a sample size may still suffer from the above noted rater bias. And, a large sample size does not necessarily indicate a higher quality of a mean score. This situation commonly occurs when the sample lacks diversity. For example, a rater who desires to negatively or positively influence the overall results could hypothetically enter multiple low or high ratings in an attempt to skew the results. Therefore, simply reporting the mean score along with the number of ratings used to calculate the mean score, as is commonly done, can mislead the viewer.

Therefore, it would be very advantageous to have a system and method for (1) aggregating a multitude of ratings, (2) assessing the quality of each rating, (3) calculating a score based on (1) and (2), and (4) transforming the score into a new output, the “visual indicator”, which visually communicates both the significance of the score and the quality of the score. Such a system would create and output, or enable the output of, the visual indicator. Because the visual indicator would be a novel transformation containing both the calculated score combined along with an indication as to the quality of the score, the individual viewing the score would not need to analyze any other data to determine the quality of the score. This would enable rapid visual stratification of ratings and immediate identification of high quality ratings.

U.S. Pat. No. 7,003,503 teaches a method of ranking items and displaying a search result based on weights chosen by the user. U.S. Pat. No. 6,944,816 allows entry of criteria to be used in analysis of candidates, the relative importance value between each of the criteria, and raw scores for the criteria. The results are computed and placed in a spreadsheet. U.S. Pat. No. 6,155,839 provides for displaying test questions and answers as well as rules for scoring the displayed answer. U.S. Pat. No. 6,772,019 teaches performing trade-off studies using multi-parameter choice. Choice criteria are weighted using pair-wise comparisons to minimize judgment errors. Results can be made available to an operator in formats selectable by the operator. U.S. Pat. No. 6,529,892 generates a confusability score among drug names using similarity scores. U.S. Patent Application Number 2008/0120166 (Fernandez) teaches a method for obtaining a ranking of a rating by requiring the use of human input to weight the quality of each rater providing the rating and displaying a visual indicator in close proximity to the rating. None of the prior art teaches a system and method for creating a new visual indicator using ratings and information gathered about each rater from non-human inputs which are transformed into an output that is easily understood and provides an individual viewing the visual indicator knowledge of the rating along with an understanding of the quality of the rating.

### SUMMARY OF THE INVENTION

The present invention relates to a system and method for transforming multiple ratings about a subject and disparate data regarding both the ratings and raters of the subject into a unique visual indicator that, when output, conveys to the viewer an aggregated score of the ratings along with an indication as to the quality of the score.

In addition to the rating or score itself, the visual indicator represents the quality of the displayed score or rating through the use of one or more of: (a) a color or series of different colors such as green, yellow, red; (b) icons such as thumbs up or thumbs down; (c) a series of multiple icons such as two thumbs up, one thumb down, etc.; (d) a visual quality such as luminance, size, density, or thickness. The visual quality indicator may also be text or a graphic. Any type of quality indicator associated with or integral to a score or rating is within the scope of the present invention. Scores or ratings may be supplied into the present invention that have been processed by others (for example those who took a particular survey). In this case, the present invention can calculate the quality of the score or rating, and combine the quality indicator with the score or rating to create a new visual indicator which may be output or stored for later output. In other cases, the present invention can be supplied with raw data from surveys or other sources, can reduce that data using any type of mathematical or statistical technique, and then output the reduced score or rating values along with associated qualities. In addition, the quality of the score or rating inherent to the new visual indicator may be used to create output in some other format, such as in a sorted or filtered list.

### DESCRIPTION OF THE DRAWINGS

Attention is now directed to the following drawings that are being provided illustrate the features of the present invention:

FIG. 1a shows output of a set of scores or ratings using color to indicate quality.

FIG. 1b shows an alternate output of the same set of scores or ratings from FIG. 1a.

FIG. 1c shows an alternate output of the same set of scores or ratings from FIG. 1a.

FIG. 2 shows output of a set of scores or ratings using a single icon to indicate quality.

FIG. 3 shows output of a set of scores or ratings using multiple icons to indicate quality.

FIG. 4 is a block diagram depicting one method the present invention can use to determine quality.

FIG. 5 shows network aspects of the present invention.

FIG. 6 shows various alternate output options of the same set of scores or ratings from FIG. 1a.

FIG. 7. shows an alternate output of the same set of scores or ratings from FIG. 1a.

FIG. 8. shows one example of variables being supplied to the computation engine and the resulting output from the computation engine.

FIG. 9. depicts one example of the sequence of steps the production engine can use to create visual indicators.

The drawings and illustrations have been presented to aid in understanding the present invention. The scope of the present invention is not limited to what is shown in the figures.

### DESCRIPTION OF THE INVENTION

The present invention is a system and method that allows computation of a quality measure for each score or rating in a set of scores or ratings, creates a new visual indicator that combines the rating or score along with the quality measure, and allows or enables output (on any type of device or material) of the visual indicator in a way that a user can determine both the rating or score and the overall weight or significance to attribute to the particular score or rating. The resulting visual indicator, via its integral quality measure, may also be used by a user or a computation device to sort or filter a list of scores or ratings based on their quality measure, enabling the preferential output of those scores or ratings with a desired quality measure.

As previously discussed, surveys are regularly taken to assess people, places, events, products or services. In addition, numerous other scores or ratings are generated every day relating to people, places, events, products or services. A person may be a private individual, a professional, a public figure, or group of individuals, professionals or public figures. A place may be a physical location, a company, or an organization, A thing may be a product, device, equipment, food, beverage or any other tangible substance. A service may be provided by or to any person, place or thing.

An individual viewing these ratings has no way to determine exactly what the score or rating means. For example, if one item had an overall rating of 85% and a second item only had a rating of 65%, the ratings are meaningless and possibly misleading if these scores were determined by different methods using different sample sizes or biases of raters or by many other factors. In contrast, if these two scores were output with the 65% rating having a related icon of 4 “thumbs up” symbols with the 85% rating having a “thumbs down” symbol, the user could immediately tell that the 85% score might be bogus or at least suspect. In this case, the user might determine that the product with the very solid 65% score really was the best choice. In another example, if two items both received an “A” rating, the user would not be able to differentiate between the two items using only the provided rating information. However, if the first item was represented by a green colored “A”, while the second item was represented by a red colored “A”, the user could immediately tell that the item represented by the green colored “A” is preferred over the item represented by the red colored “A”.

The present invention includes different mechanisms to both determine the quality of a score or rating and produce a visual indicator. In producing a visual indicator, the system can consider any information collected regarding how a score or rating was determined including how large the sample size was, the number of ratings, any known bias in the sample, the recentness of the sample, mechanism of scoring, or individual(s) contributing to the score including information about the individual(s) providing the raw data such as their level of prior participation in surveys or attendance or purchases, their level of education, their IP (internet protocol) address, or a personal identifier such as their e-mail address, social security number, tax ID number or other unique identifier. The system can accept any other information about the source of the score or rating for use in determining the quality of the score or rating.

The collected information may come from the source of the ratings or raw data from surveys or other sources. The present invention may reduce collected data using various statistical methods, and generate final scores along with a quality factor for each score. After the ratings and their quality factors are determined, the system and method of the present invention can transform the ratings and their quality factors into a new visual indicator which may be stored in a database, communicated to another device, or output.

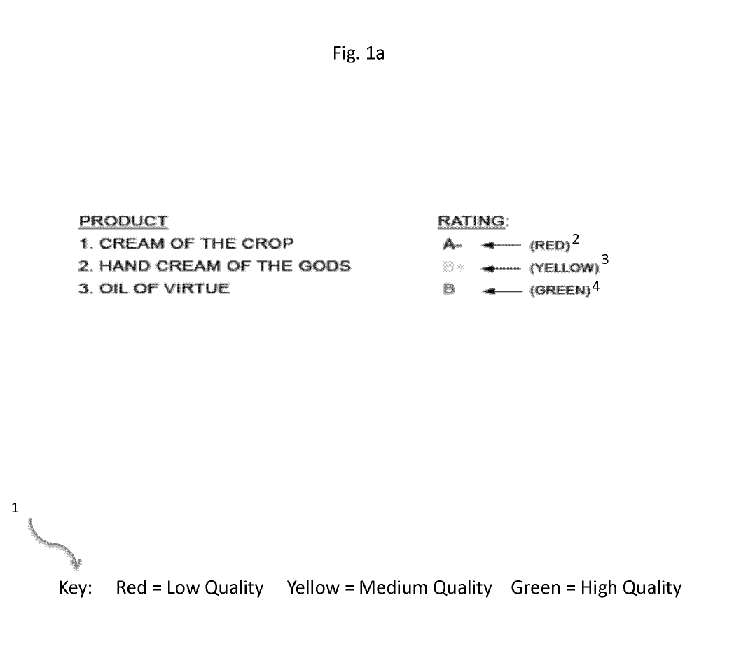

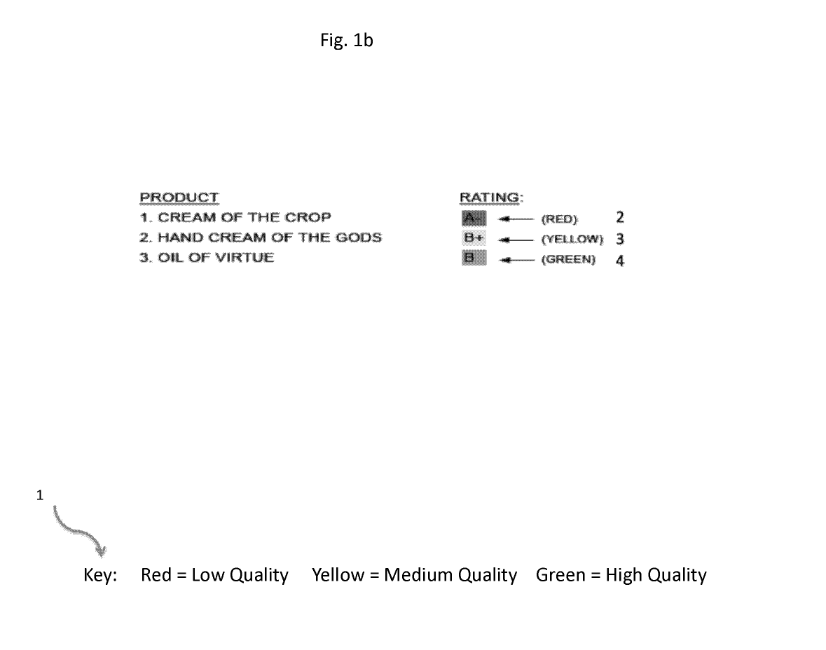

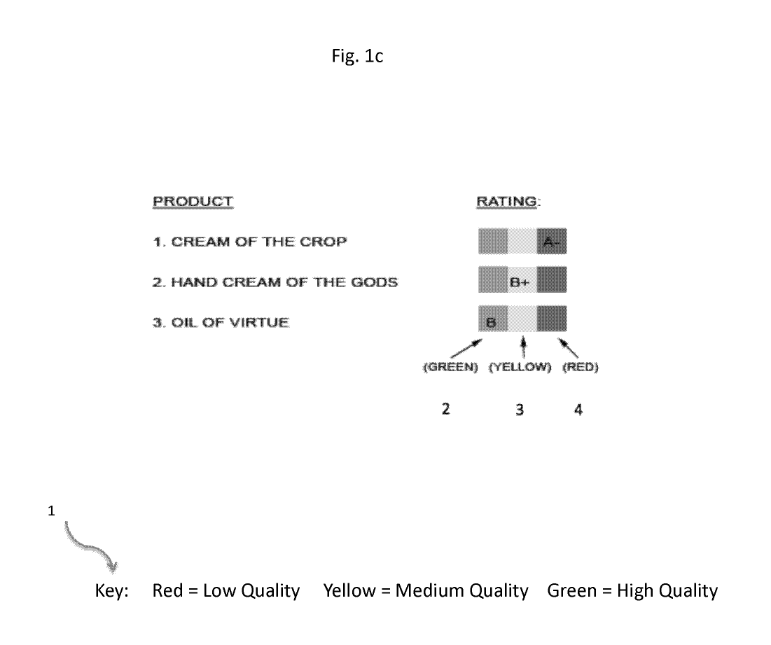

The creation of different types of visual indicators is possible by the system. In one implementation of the present invention, the indicator used to represent the quality factor may be a color or include a color. In this case, the score or rating itself could be output in color, thus integrating the quality indicator within or as a part of the original score or rating. For illustrative purposes only, FIG. 1a, shows an example of the preferred embodiment where each rating and the quality indicator are transformed into a new visual indicator and output from a device capable of color output. A key 1 shows that red=low quality, yellow=medium quality, and green=high quality. While colors cannot be seen in FIG. 1a, the “A−” score for the first product is output as red 2, the “B+” score for the second product is output as yellow 3, and the “B” score for the third product is output as green 4. This example indicates that the green “B” score for the third product is very reliable, while the yellow “B+” score for the second product may be suspect. Although the first product has a rating of “A−”, the user would know from the associated quality indicator (in this case, a red color) that the score for the first product is very unreliable. Based on the quality indicator, the output could be sorted or filtered prior to output.

FIG. 1b and FIG. 1c demonstrate alternate implementations of the same output from FIG. 1a, where the output incorporates the rating or score within the visual indicator.

Similarly, the level of intensity and/or amount of luminance may be used as an indication of quality. When colors and/or luminance are used to indicate the quality of ratings or scores, the degree of quality (e.g. from low to high, weak to strong, or poor to good) may be easily ascertained by the viewer. In addition, the colors and/or luminance may be used to stratify groupings of ratings. As noted above, a typical scenario involves the use of a green color to indicate high quality, yellow for moderate quality, and red for poor quality. Because both colors and luminance are present within a continuous spectrum, categories of intermediate quality could be output using an intermediate color and/or luminance. For example, “moderate-high” quality could be displayed as a yellow-green color.

In other applications, the visual “weight” of the indicator (measured in pixels or pica, for example) may be used as an indication of quality. For example, a low quality score may be represented by smaller visual weights, and high quality scores may be represented by greater visual weights.

To facilitate interpretation of the quality indicator, use of a visual device consisting of a bounded range (eg. color, luminence, weight, size, etc.) is the preferred implementation of the invention, but not a requirement. One skilled in the art will recognize that many visual devices with bounded ranges exist, any of which may be used in the invention either individually or combined. When a visual device with a bounded range is used in the present invention, the invention may correlate the quality measure with the bounded range, thus avoiding the need for arbitrary assignments by a human. Indeed, as the system receives more information, the system itself can create unique quality indicators consisting of various visual devices (eg. color, luminence, weight, size, etc.) within a spectrum of bounded ranges.

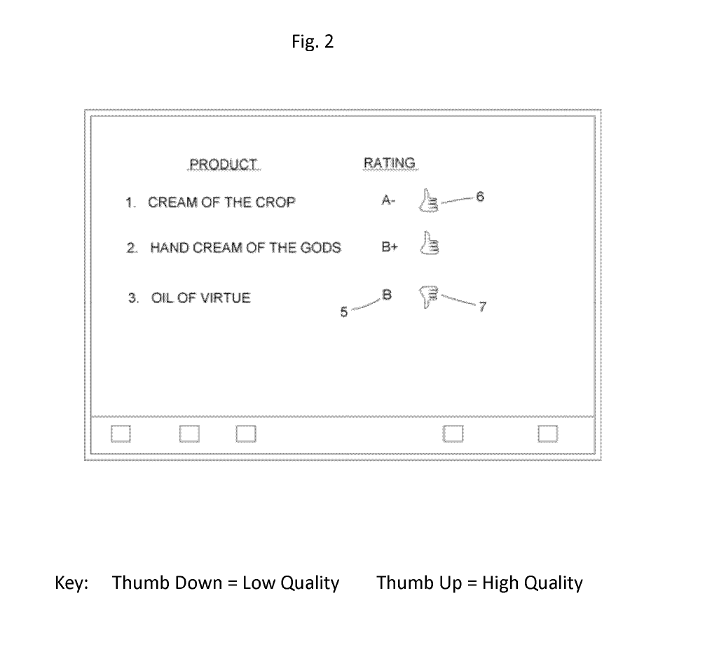

FIG. 2 shows a binary situation where the quality of the score 5 is shown by a single thumbs up 6 or a single thumbs down 7.

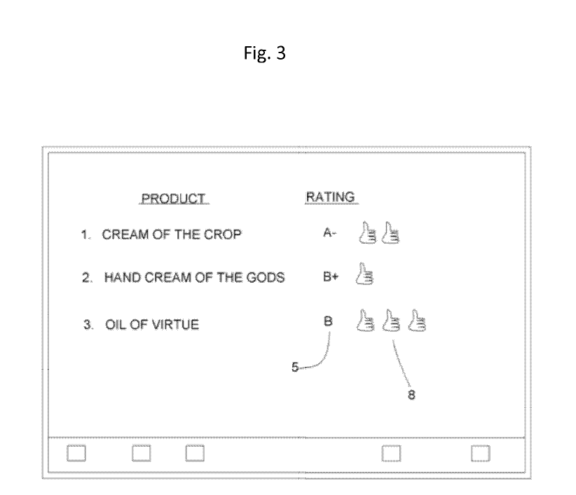

FIG. 3 shows a sliding scale using icons. The score 5 can get multiple thumbs up icons 8 such as one, two or more to give more resolution to the presentation of the quality measure than would be permitted by the limited binary model of FIG. 2. It should be noted that while the thumbs up or thumbs down icon has been used in FIG. 3, any indicator of quality whatsoever or any quality icon or icons are within the scope of the present invention.

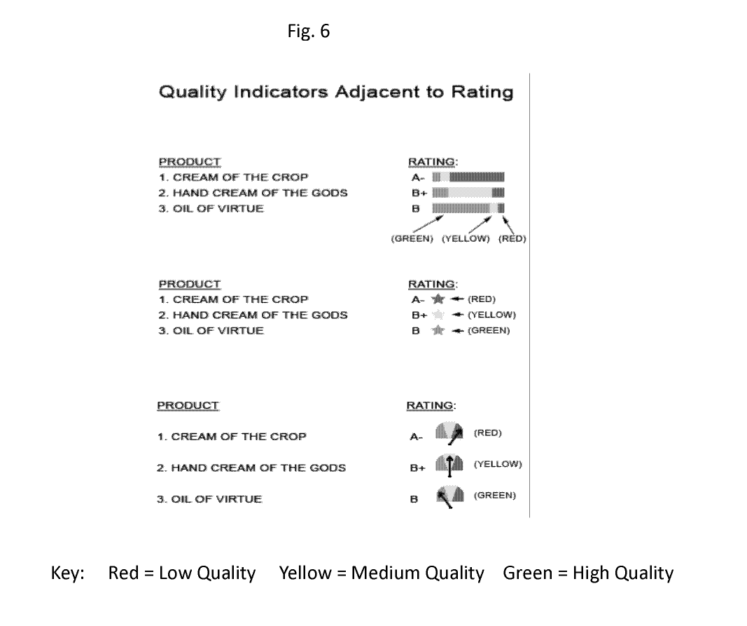

For example, FIG. 6 shows examples implementing different visual representations of quality indicators adjacent to each rating. In each of the examples, the output simultaneously communicates to the viewer both the rating and the quality of the rating. As an example only, in each of the illustrations (FIG. 6) the green color represents a high quality rating, the yellow color represents a moderate quality rating, and the red color represents a poor quality rating.

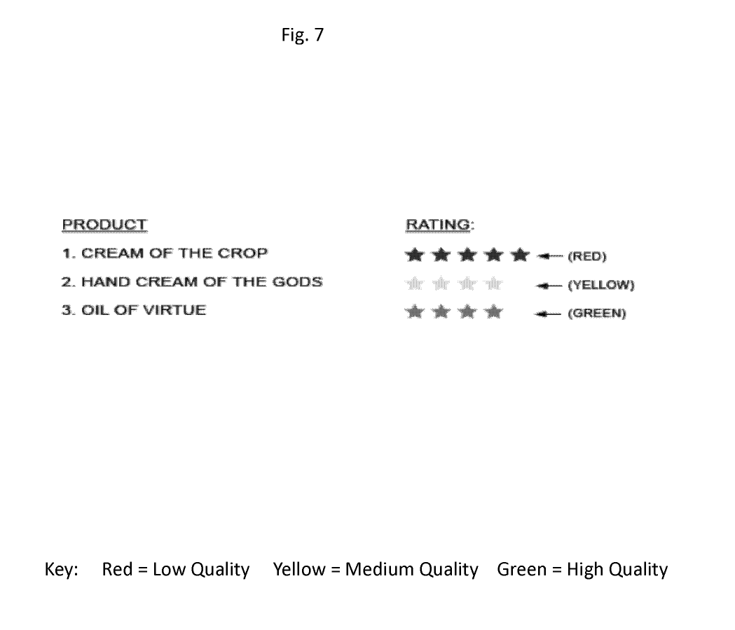

In one implementation of the present invention, FIG. 7, ratings or aggregate scores can be represented by stars, and the quality of the rating or score by colors. In this case, the rating and the quality indicator are combined into a single visual indicator. For example, a subject with a rating of 4 (out of a possible maximum 5) and with a high quality score could be represented as four green stars. In contrast, another subject with a rating of 5 but with a low quality score could be represented as five red stars. In this case, the user viewing the output would instantly know that the subject with four green stars is a better choice than the subject with five red stars.

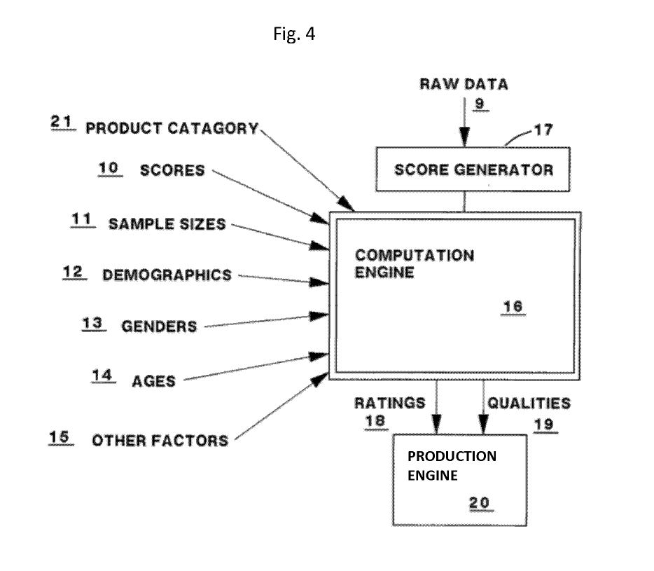

FIG. 4 shows a flow chart of an embodiment of the present invention where raw data 9 or finished scores 10 as well information on how the scores or data was determined such as product category 21, sample sizes 11, demographics 12, sample gender composition 13, rater's age groups 14, and other quality determining factors 15 are fed into a quality computing engine 16. Raw data 9 can be fed into a score generator 17. The rating results 18 as well as quality measures 19 are then fed into the production engine 20 which creates visual quality indicators by combining ratings with a quality indicator such as colors or icons, as described, or in any other form.

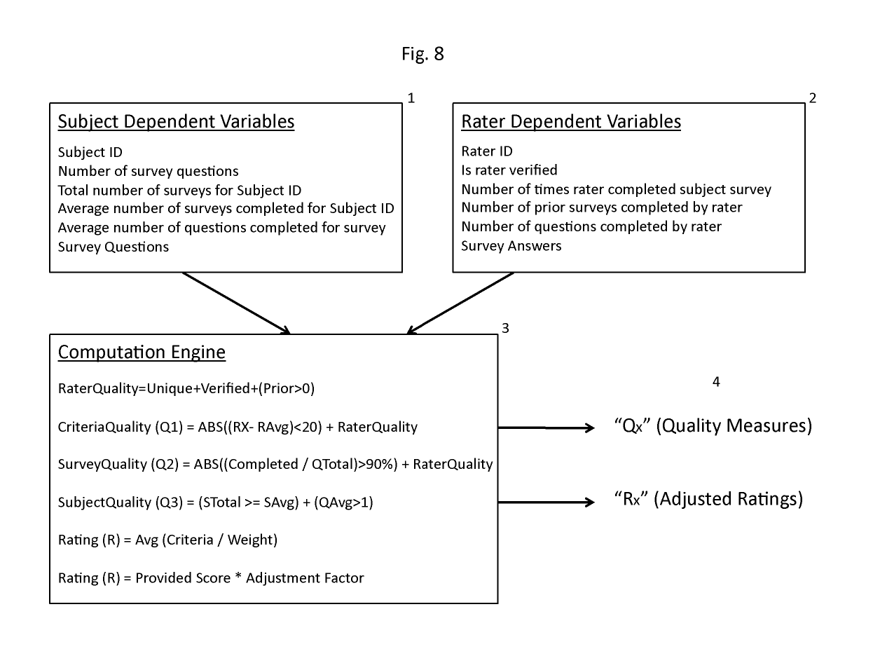

FIG. 8 shows a flow diagram of how the computation engine operates. Survey dependent variables 1 and rater dependent variables 2 are fed into the computation engine 3. The computation engine dynamically computes adjusted ratings and associated quality measures 4 for each adjusted rating. The quality measures (“Qx”) derived from the computation engine change with the addition of new surveys and the completion of surveys by raters. Adjusted ratings (“Rx”) may be calculated using basic math or advanced statistical computations. The adjusted ratings may be supplied to or calculated by the computation engine. Recursive calculations may be performed by the engine to create new visual indicators as additional data becomes available through derived calculations or external input. The subject dependent variables, rater dependent variables, and computation engine formulae shown in FIG. 8 are examples only.

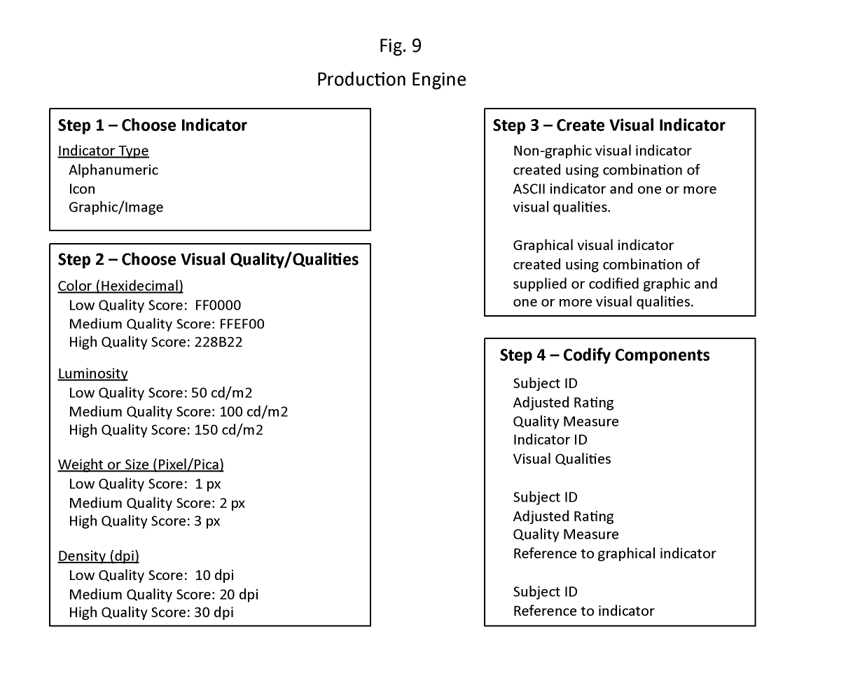

FIG. 9 shows a stepwise sequence of how the production creates a visual indicator for each subject. In step 1, the engine selects an indicator type compatible with the desired output. Selection of the indicator type may be independent of the quality measure. Multiple passes through the production engine may be performed for each subject surveyed, resulting in the ability to assign more than one indicator type to any subject. In step 2, the production engine selects one or more visual qualities, compatible with the desired output and indicator type, for each adjusted rating. In step 3, the production engine combines adjusted ratings with their selected indicators and their selected visual qualities. In step 4, the production engine provides codified results of visual indicators for storage in a database or to a device capable of creating or enabling output. Different components may be codified for final output or storage, depending on the type of indicator selected and the intended output device. The production engine may convert the codified components as needed for different storage or output requirements. The visual indicator may be stored for later retrieval or output at the time of creation. The visual indicator is represented using data elements which are interpreted by a computation or output device using common codification-decodification techniques (eg. ASCII, Hex, HTML) or described internally (eg. XML).

The inputs from all raters for each question can be used in a formula for computing the quality of the overall rating. The system may optionally allow one or more individuals (system operators or raters) to select which items (or groups of items) used to calculate ratings or quality factors are most important and thereby obtain a rank-order or weight of each quality factor or rating. The ability of the system to optionally accept human input demonstrates the flexibility of the system, rather than a limitation of the system.

Using SURVEY dependent variables and RATER dependent variables, the quality of a single rating/score or a group of ratings/scores can be determined using various formulas.

### Survey Dependent Variables:

Subject=person/place/thing/event
R_{Avg}=average rating of all completed questions for a single Survey
Q_{Total}=the total number of questions in the Survey
S_{Total}=the total number of Surveys for a given Subject
S_{Avg}=the average number of Surveys completed per Subject

### Rater Dependent Variables:

Verified=the Rater's identity has been verified or the Rater is anonymous (−2=anonymous, 1=verified)
Completed=the number of questions in the Survey completed by the Rater
Unique=the Rater has completed the Subject survey once (−2=not unique, 1=unique)
Prior=the number of surveys previously completed by the Rater on different Subjects

RaterQuality=Unique+Verified+(Prior>0)

The above RaterQuality formula combines multiple criteria about a Rater. For example, if the Rater has completed prior surveys on different Subjects, the Rater is considered to be more reliable and the RaterQuality is increased by a factor of “1”. If the Rater has completed the survey more than one time (e.g. the Rater is attempting to skew the average result), the RaterQuality is decreased by a factor of “2”. If the Rater is not anonymous, the RaterQuality is increased by a factor of “1”, otherwise it is reduced by a factor of “2”. Because there are dynamic components to the RaterQuality in this example, it is possible that the RaterQuality can be changed over time.

Using the above variables, if multiple Subjects are rated/scored based on multiple criteria by multiple raters, then a determination can be made about the Quality (Q) of: (a) the rating/score of each question/criteria; (b) the overall rating/score of a completed survey (based on, for example, the average or weighted average of all questions/criteria in the survey); or (c) the rating/score of a Subject based on all completed surveys regarding the Subject.

The Quality (Q) will be influenced by the ratings/scores themselves as well as information about the Rater (RaterQuality). Calculation of the Quality (Q) may be a static process (once the Quality has been determined, the Quality will not change if the survey is closed to new input by the Rater) or a dynamic process (the Quality may change if the survey is open to new input by the Rater or if new information is gathered about the Rater).

Once the Quality (Q) has been determined, a third party (an individual or computer system) could subsequently analyze a table of responses consisting of multiple Raters' qualified responses and decide, perhaps, to ignore responses codified as having a poor Quality.

### Example Formulas

The following are provided as examples to illustrate aspects and features of the present invention. The scope of the present invention is not limited to what is shown in the following examples.

### A. Quality of a Single Criteria Rating of a Subject

The rating/score of any single question/criteria (R_{X}) about a Subject may be qualified, for example, based (1) on how the rating/score (R_{X}) compares to the average of all ratings/scores (R_{Avg}) in the Survey and (2) on information derived about the Rater (above). Other variables such as Rater Quality may be used in the equation to further evaluate the quality of a single criteria.

Quality (Q)=ABS((R_{X}−R_{Avg})<20)+RaterQuality

In the above example, if the individual rating/score (R_{X}) is more than 20% from the average of all ratings/scores in the survey, the Quality (Q) is reduced by a factor of “1”. The effect of this calculation, for example, is to reduce the weight of any rating/scoring outside of the standard bell-curve distribution of all ratings/scorings for this Survey.

Therefore, the Quality (Q) result will range from “−4” to “4”. A quality indicator may be assigned to each calculated Quality (Q) score, based on a specific numeric score or range of scores.

| Calculated | | |
|---|---|---|
| Quality | Assessment | Quality Indicator Example |
| Q < 0 | Poor | Rating/Score shown in red color or with |
| | | “thumbs down” icon |
| 0 < Q < 3 | Average | Rating/Score shown in yellow color or with one |
| | | “thumbs up” icon |
| Q > 2 | Superior | Rating/Score shown in green color or with two |
| | | “thumbs up” icons |

### B. Quality of a Completed Survey

The overall rating/score of a Survey (a set of questions/criteria completed by one Rater) can be used to compare multiple Surveys. The overall rating/score of an individual Survey may be calculated from the multitude of responses to the questions/criteria in the Survey regarding a Subject as well as Rater specific information (above). In addition to Rater-based criteria (RaterQuality), in the following example, a completed Survey has a higher calculated Quality (Q) if more than 90% of the questions in the Survey were answered by the Rater. Other variables may be used in the equation to further evaluate the quality of a Survey.

Quality (Q)=ABS((Completed/Q_{Total})>90%)+RaterQuality

Therefore, the Quality (Q) of a given Survey will range from “−4” to “4”. A quality indicator may be assigned to each calculated Quality (Q) score, based on a specific numeric score or range of scores.

| Calculated | | |
|---|---|---|
| Quality | Assessment | Quality Indicator Example |
| Q < 0 | Poor | Rating/Score shown in red color or with |
| | | “thumbs down” icon |
| 0 < Q < 3 | Average | Rating/Score shown in yellow color or with one |
| | | “thumbs up” icon |
| Q > 2 | Superior | Rating/Score shown in green color or with two |
| | | “thumbs up” icons |

### C. Quality of a Subject

The overall rating/score of a Subject can be used to compare multiple Subjects. The overall rating/score of each Subject may be calculated from multiple Surveys regarding each specific Subject. If many high-quality completed Surveys are available for a Subject, then the quality of the Subject may be inferred. In the following example, the number of completed Surveys for a Subject (S_{Total}) must be at least as good as the average number of Surveys (S_{Avg}) for all Subjects. Also, the average Quality (Q) of all Surveys for a Subject (e.g. the average of all Survey Quality assessments calculated in “B” above for a Subject) must be at a specified threshold. Other variables may be used in the equation to further evaluate the quality of a Subject.

Quality (Q)=(S_{Total}>=S_{Avg})+(Q_{Avg}>1)

Therefore, the Quality (Q) of a Subject will range from “0” to “2”. A quality indicator may be assigned to each calculated Quality (Q) score, based on a specific numeric score or range of scores.

| Calculated | | |
|---|---|---|
| Quality | Assessment | Quality Indicator Example |
| Q = 0 | Poor | Rating/Score shown in red color or with |
| | | “thumbs down” icon |
| Q = 1 | Average | Rating/Score shown in yellow color or with one |
| | | “thumbs up” icon |
| Q = 2 | Superior | Rating/Score shown in green color or with two |
| | | “thumbs up” icons |

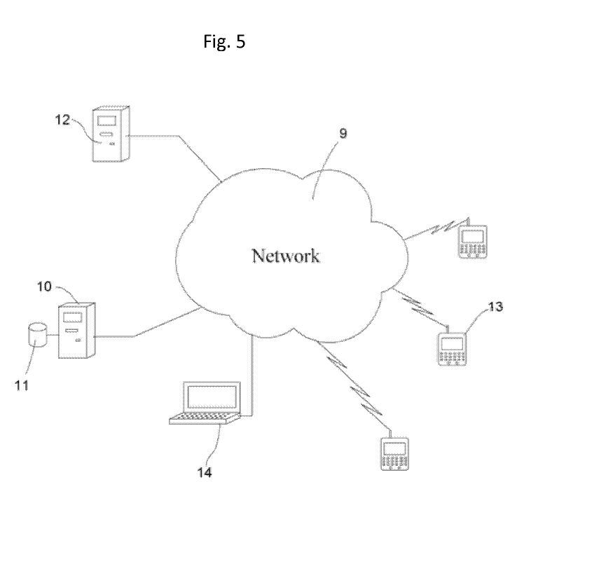

FIG. 5 shows network aspects of the present invention. Part of the system can reside on a computer or server 10. External data storage 11 may optionally be directly connected to the computer or server 10, or the external data storage may be connected to any other part of the network. The computer or server 10 can be any type of computer including a frame server, PC server, PC, laptop, smart-phone, cellphone or any other type of computing device. This computer typically has a processor, internal memory, data storage, and communication capability such as wired or wireless systems. The computer or server 10 can communicate with a network 9 that can be the Internet, World Wide Web, a local network, a wide area network or any other type of network. Communication with the network can be by wire or any wireless transmission protocol including, for example, radiofrequency (eg. cellular telephone, WiFi), microwave, ultrasonic, and light-based protocols. Part of the system of the present invention can optionally reside on one or more servers anywhere in the network (including a virtualized environment or cloud computing environment) and be distributed. Users can typically use PCs 12, laptops 14, telephones or tablet devices 13 to communicate with the system. Each computer or server 10 in the network 9 is adapted to receive and store ratings or scores by being connected to the network and by having a connection with sufficient internal or external storage. Inputs can come from anywhere in the network or any device with any type of connection to the network, and outputs can be sent to any location in the network or any device with any type of connection to the network 9. The network 9 can contain switches, routers, fiber optic converters and any other type of network equipment. Any device with any type of connection to the network 9, may send a request to the computer or server 10 regarding any survey or subject processed by the computer or server 10, and the computer or server 10 may output to the requesting device via the network 9, or any device via any other communication mechanism, the then current rating or score with associated quality indicator of the survey or subject. Additionally, the computer or server 10 may store, publish or broadcast at any time the then current rating or score with associated quality indicator of any survey or subject to the network 9 or any device capable of communicating with the computer or server 10 in any fashion. Because the system may receive or obtain additional data from many unrelated sources, a computing machine is required to automatically generate new, up-to-date quality indicators for storage, publication or output.

Output data can be requested remotely over the network with the data being provided directly to the requesting device using a communication protocol including, but not limited to, HTML, XML, JSON or POST data. While these are preferred data or file formats, any data format or file format is within the scope of the present invention.

Several descriptions and illustrations have been presented to aid in understanding the features of the present invention. One with skill in the art will realize that numerous changes and variations are possible without departing from the spirit of the invention. Each of these changes and variations are within the scope of the present invention.

I claim:

1. A system to generate visual indicators created from scores or ratings combined with associated quality indicators, the system comprising:
a computer device adapted to receive a plurality of survey dependent variables including compiled ratings or scores regarding a particular subject, the computer device storing said survey dependent variables in a database;
said computer device also configured to receive and store a plurality of rater dependent variables including a source of each of said ratings or scores and a sample size for each of said ratings or scores, the computer device storing said rater dependent variables in the database;
a computation engine configured to transform said ratings or scores using the survey dependent variables and the rater dependent variables to produce adjusted ratings or scores and associated quality values for each adjusted rating or score, the computer device storing said adjusted ratings or scores and associated quality values for each adjusted rating or score in the database;
said computation engine configured to create a visual indicator based on the adjusted ratings or scores and associated quality values for each adjusted rating or score, the computer device storing the data elements which define the visual indicator in the database;
said database configured to allow a networked device to retrieve one or more said adjusted ratings or scores with their associated quality values or the data elements which define their visual indicators;
said computer device configured to send one or more of said adjusted ratings or scores and the associated quality values for each rating or score or data elements which define the visual indicator for each rating or score to an output device or networked device capable of outputting said adjusted ratings or scores and associated quality values;
said output device or said networked device outputting said visual indicator or quality values for each adjusted rating or score as visual quality indicators together with or integral to said adjusted ratings or scores.

2. The system of claim 1 wherein said visual quality indicators are (a) colors, (b) luminosity, density, or (c) size.

3. The system of claim 1 wherein said visual quality indicators are (a) icons, (b) graphic images, or (c) text.

4. The system of claim 1 wherein said computation engine may use additional information about said ratings or scores including product category, demographics, sample gender composition or rater's age groups to produce said associated quality values.

5. The system of claim 1 wherein said ratings or quality indicators relate to a person, service, event, place or thing.

6. The system of claim 1 wherein input information includes at least one of product category, service category, demographics, sample gender composition, rater's age groups, level of prior participation, purchases, education level, communication address or unique personal identifier.

7. The system of claim 1 wherein said computation engine receives said survey dependent variables and/or said rater dependent variables over a network.

8. The system of claim 1 wherein quality values associated with a rating or score may be updated by the computing engine in realtime.

9. The system of claim 1 wherein said database may be updated with re-computed quality values.

10. The system of claim 1 wherein said computer device provides data consisting of one or more ratings or scores along with their associated quality value to a requesting device via a network.

11. The system of claim 10 wherein said data is provided directly to the requesting device using a communication protocol including, HTML, XML, JSON or POST data.

12. The system of claim 10 wherein said data is provided indirectly to the requesting device using a communication protocol including, e-mail or a shared file system.

13. The system of claim 1 wherein said networked device retrieves data including one or more ratings or scores along with their associated quality value from said database via a network.

14. A system to generate visual indicators created from scores or ratings combined with associated quality indicators, the system comprising:
a computer adapted to receive a plurality of survey dependent variables including compiled ratings or scores regarding a particular subject, the computer storing said survey dependent variables in a database;
said computer also configured to receive and store a plurality of rater dependent variables including a source of each of said ratings or scores and a sample size for each of said ratings or scores, the computer storing said rater dependent variables in the database;
a computation engine configured to transform said ratings or scores using the survey dependent variables and the rater dependent variables to produce adjusted ratings or scores and associated quality values for each adjusted rating or score, the computer storing said adjusted ratings or scores and associated quality values for each adjusted rating or score in the database;
said computation engine configured to create a visual indicator based on the adjusted ratings or scores and associated quality values for each adjusted rating or score,
said database configured to allow a networked device to retrieve one or more of said adjusted ratings or scores with an associated quality value or said visual indicators over a network.

15. The system of claim 14 wherein input information includes at least one of product category, service category, demographics, sample gender composition, rater's age groups, level of prior participation, purchases, education level, communication address or unique personal identifier.

16. The system of claim 14 wherein said ratings or quality indicators relate to a person, service, event, place or thing.

17. The system of claim 14 wherein said networked device retrieves data including one or more ratings or scores along with their associated quality value from said database via a network.

18. A method for generating visual indicators created from scores or ratings combined with associated quality indicators, the system comprising:
receiving on a computer a plurality of survey dependent variables including compiled ratings or scores regarding a particular subject, the computer storing said survey dependent variables in a database;
receiving and storing on said computer a plurality of rater dependent variables including a source of each of said ratings or scores and a sample size for each of said ratings or scores, the computer storing said rater dependent variables in the database;
transforming said ratings or scores with a computation engine using the survey dependent variables and the rater dependent variables to produce adjusted ratings or scores and associated quality values for each adjusted rating or score, the computer storing said adjusted ratings or scores and associated quality values for each adjusted rating or score in the database;
creating a visual indicator based on the adjusted ratings or scores and associated quality values for each adjusted rating or score with said computation engine,
allowing a networked device to retrieve one or more of said adjusted ratings or scores with an associated quality value or said visual indicators over a network from said database.

19. The method of claim 18 wherein said ratings or quality indicators relate to a person, service, event, place or thing.

20. The method of claim 18 wherein said networked device retrieves data including one or more ratings or scores along with their associated quality value from said database via a network
